(19) United States
(12) Patent Application Publication
(10) Pub. No.: US 2026/0290869 A1
(43) Pub. Date: Sep. 24, 2026

(54) METHOD FOR BOOSTING A REDOX FLOW BATTERY, A MEMBRANE DEVICE, A MEMBRANE STACK, AND A SYSTEM TO PERFORM SAID METHOD

(71) Applicant: AQUABATTERY B.V., Alphen aan de Rijn (NL)

(72) Inventors: Jiajun Cen, Alphen aan den Rijn (NL); Kaustub Kaustub, Alphen aan de Rijn (NL)

(21) Appl. No.: 19/469,988

(22) PCT Filed: Mar. 28, 2024
(86) PCT No.: PCT/EP2024/058671

§ 371 Date: Sep. 26, 2025

(30) Foreign Application Priority Data
Mar. 28, 2023 (NL) 2034448

(51) Int. Cl. H01M 8/18; H01M 8/04858; H01M 8/22

(52) U.S. Cl. CPC H01M 8/188; H01M 8/04925; H01M 8/227

(57) ABSTRACT

Disclosed is a method, device, membrane stack, and system for boosting a redox flow battery with a membrane device comprising:
n triplet of membranes, wherein n is an integer of 1 or more, and wherein each triplet of membranes consists of an anion exchange membrane, a bipolar membrane, and a cation exchange membrane; and
3n+1 compartments, wherein one of the compartments comprises a cathode and wherein another of the compartments comprises an anode, and wherein the 3n+1 compartments are at least partly delineated by one of the triplet of membranes;
circulating a catholyte to the compartment with the cathode;
circulating an anolyte to the compartment with the anode; and
charging the redox flow battery by applying an electrical potential difference between the anode and the cathode and/or providing charged catholyte to the compartment with the cathode and anolyte to the compartment with the anode

### REFERENCE TO RELATED APPLICATIONS

This application is a national stage application under 35 U.S.C. § 371 which claims the benefit of the filing date of PCT/EP2024/058671 titled “Method For Boosting A Redox Flow Battery, A Membrane Device, A Membrane Stack, And A System To Perform Said Method” and filed 28 Mar. 2023, which claims the benefit of Netherlands U.S. Pat. No. 2,034,448, titled “Method For Boosting A Redox Flow Battery, A Membrane Device, A Membrane Stack, And A System To Perform Said Method”, filed 28 Mar. 2023, and granted 8 Oct. 2024, the subject matter of each of which is incorporated herein by reference.

### CROSS REFERENCES

Not applicable.

### STATEMENT REGARDING FEDERALLY SPONSORED RESEARCH OR DEVELOPMENT

Not applicable.

INCORPORATION BY REFERENCE OF MATERIAL SUBMITTED ON A COMPACT DISK

Not applicable.

### TECHNICAL FIELD

The present invention relates to a method for boosting a redox flow battery with a membrane device, a device, a membrane stack, and a system to perform said method.

### BACKGROUND OF THE DISCLOSURE

The increasing energy demand and the impact of said energy demand on the environment are rising. Said issues pose a significant thread to the sustainable development of renewable energy sources. It is known that renewable energy sources such as wind and solar presents a barrier to their large-scale implementation. Furthermore, fluctuations in renewable energy production could endanger the power grid if directly integrated. A problem affiliated with the large-scale implementation is that efficient and effective means for electricity storage over periods of time are expensive and/or use a lot of space. The (temporarily) storage of a surplus of energy could be via electrochemistry, wherein the stored charge can be converted back to electrical power with high round-trip efficiency.

Alternatively, aqueous redox flow batteries may be used for storing and providing (stored) energy. To compete with alternative storage methods, improvements in energy and power density are needed.

### BRIEF SUMMARY OF THE DISCLOSURE

An objective of the present invention is to provide a method for boosting a redox flow battery with a membrane device that obviates or at least reduces one or more of the aforementioned problems and/or is more effective as compared to conventional methods and systems.

This objective is achieved with a method for boosting a redox flow battery with a membrane device comprising the steps of providing the redox flow battery with the membrane device comprising: n triplet of membranes, wherein n may be an integer of 1 or more, and wherein each triplet of membranes consists of an anion exchange membrane, a bipolar membrane, and a cation exchange membrane; and 3n+1 compartments, wherein one of the compartments comprises a cathode and wherein another of the compartments comprises an anode, and wherein the 3n+1 compartments are at least partly delineated by one of the triplet of membranes; circulating a catholyte to the compartment with the cathode; circulating an anolyte to the compartment with the anode; and charging the redox flow battery by applying an electrical potential difference between the anode and the cathode and/or providing charged catholyte to the compartment with the cathode and anolyte to the compartment with the anode.

### BRIEF DESCRIPTION OF THE DRAWINGS

Further advantages, features and details of the invention are elucidated on the basis of preferred embodiments thereof, wherein reference is made to the accompanying drawings, in which:

FIG. 1 shows a schematic overview of the method according to the invention;

FIG. 2 shows a schematic overview of the membrane device according to the invention comprising one triplet of membranes in the discharging state;

FIG. 3 shows a schematic overview of the membrane device according to the invention comprising two triplet of membranes in the discharging state;

FIG. 4 shows a schematic overview of the membrane device according to the invention comprising multiple triplet of membranes;

FIG. 5A shows a profile of a current sweep;

FIG. 5B shows the corresponding voltage profiles of the current sweep;

FIG. 6A shows a profile of a current sweep;

FIG. 6B shows the corresponding voltage profiles;

FIG. 7 shows the heating of the flow streams influence on the voltage response;

FIG. 8A shows the voltage response of boosting a redox flow battery; and

FIG. 8B shows the cycle of boosting a redox flow battery.

### DETAILED DESCRIPTION

The method according to the invention may start with the step of providing the redox flow battery with the membrane device. Said membrane device may comprise n triplet of membranes, wherein n is an integer of 1 or more, and wherein each triplet of membranes consists of an anion exchange membrane, a bipolar membrane, and a cation exchange membrane, and 3n+1 compartments, wherein one of the compartments comprises a cathode and wherein another of the compartments comprises an anode, and wherein the 3n+1 compartments are at least partly delineated by one of the triplet of membranes.

It is noted that n is an integer, thus, n is a number that is not a fraction but a whole number. Providing n triplet of membranes includes three membranes for each triplet. In other words, a triplet of membranes consists of three membranes.

The membrane device comprises n triplet of membranes and 3n+1 compartments. For example, when n=1 the device has 4 compartments. In an embodiment wherein n=1, the membranes and compartments are preferably configured such that the compartment comprising the cathode is at least partly delineated by the anion exchange membrane and is adjacent to the compartment which is at least partly delineated by the anion exchange membrane and the bipolar membrane. Adjacent to said compartment is a further compartment which is partly delineated by the bipolar membrane and the cation exchange membrane. Adjacent to this compartment, the compartment which is at least partly delineated by the cation exchange membrane and comprising the anode is configured.

It is noted that other configurations of the compartments are also possible, and that n may be another (integer) value.

The step of providing the redox flow battery with the membrane device may be followed by the step of circulating a catholyte to the compartment with the cathode and the step of circulating an anolyte to the compartment with the anode. Furthermore, said circulating steps may be followed by charging the redox flow battery by applying an electrical potential difference between the anode and the cathode and/or providing charged catholyte to the compartment with the cathode and anolyte to the compartment with the anode.

Circulating the catholyte to the compartment with the cathode and/or circulating the anolyte to the compartment with the anode may include providing the catholyte and/or anolyte from a catholyte storage and/or anolyte storage respectively.

Furthermore, charging the redox flow battery by applying an electrical potential difference between the anode and the cathode and/or providing charged catholyte to the compartment with the cathode and anolyte to the compartment with the anode includes that energy is provided to the catholyte and anolyte respectively. For example, the catholyte and/or anolyte may be charged separately from the redox flow battery and as a ‘ready to go’ solution (solution suitable to be discharged) provided to the compartment with the cathode or compartment with the anode respectively.

An advantage of the method according to the invention is that the gross output power of the redox flow battery at the same applied current may be boosted. As a result, the working current of the redox flow battery may be reduced without compromising the gross power output of the cell.

Therefore, the method according to the invention is suitable for us with low open circuit potentials and electrolyte solubility.

A further advantage of the method according to the invention is that energy may be stored and released efficiently and effectively. As a result, the method according to the invention can efficiently contribute to balance an open grid energy network. It was found that the method according to the invention can balance a wider area of the power grid.

Furthermore, the method according to the invention provides a higher battery potential compared to conventional redox flow batteries. As a result, the power density of the redox flow batteries is increased and a cost-effective energy storage is achieved.

In a presently preferred embodiment according to the invention, the membrane of the membrane device consists of n triplet of membranes. Said membrane of the membrane device consists of a triplet of membranes multiplied by n.

In other words, the number of membranes present in the membrane device provided with the redox flow battery in the method according to the invention consists of n triplet of membranes.

An advantage of using n triplet of membranes is that, besides the n triplet of membranes, no additional membranes are required for boosting a redox flow battery.

As a result, a more efficient and effective method is achieved, wherein less maintenance needs to be performed compared to conventional methods.

In a further presently preferred embodiment according to the invention, the compartments of the membrane device consists of 3n+1 compartments.

In other words, the number of compartments present in the membrane device provided with the redox flow battery in the method according to the invention consists of 3n+1 compartments. Furthermore, the number of compartments is preferably a direct result of the number of triplets of membranes. For example, one triplet of membranes provides four compartments.

In a further preferred embodiment, the method according to the invention comprises charging the redox flow battery by applying an electrical potential difference between the anode and the cathode.

It was found that charging the redox flow battery by applying an electrical potential difference between the anode and the cathode provides an efficient and effective method for boosting a redox flow battery. Furthermore, applying an electrical potential difference between the anode and the cathode reduces the amount of (external) transport of the anolyte and/or catholyte. Furthermore, safety is increased as an operator performs less handlings and is less exposed to (potential) harmful/hazardous chemicals such as chemicals forming the anolyte and/or catholyte.

In a further presently preferred embodiment according to the invention, the method further comprises the step of discharging the redox flow battery. It is noted that said step may also be referred to as discharging the anolyte and catholyte.

The step of discharging the anolyte and catholyte enables to provide energy, such as electricity, to an open or closed power grid, machine, and the like.

Furthermore, the step of discharging enables to form water at the bipolar membrane, and the step of charging enables to split water at the bipolar membrane. Said reactions may be referred to as:

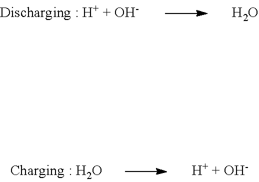

An advantage of the method according to the invention including the step of discharging is that energy can be stored and released on demand. As a result, less (renewable) energy is lost, and the potential of renewable energy sources can be increased.

It was found that the method according to the invention enhances the gross power of the redox flow battery by at least 40% at the source of the generation compared to conventional methods for boosting redox flow batteries.

In a further presently preferred embodiment according to the invention, the method further comprises the steps of providing freshwater including an acid to the compartment delineated by the anion membrane and bipolar membrane and providing freshwater including a base to the compartment delineated by the cation membrane and bipolar membrane.

It is noted that throughout this application freshwater is referred to naturally occurring water that is not salty, and is suitable for consumption if cleaned or processed. Furthermore, it is noted that freshwater comprises a salinity level of at most 0.5 part per thousand (ppt), brackish water comprises a salinity level of at most 30 ppt, saline water comprises a salinity level of at most 50 ppt, and briny water comprises a salinity level of more than 50 ppt.

It is noted that salinity refers to the saltiness or amount of salt dissolved in a body of water.

It was found that providing freshwater including an acid to the compartment delineated by the anion membrane and bipolar membrane and providing freshwater including a base to the compartment delineated by the cation membrane and bipolar membrane improves the total voltage of the redox flow battery.

In a preferred embodiment, the steps of providing freshwater including an acid to the compartment delineated by the anion membrane and bipolar membrane and providing freshwater including a base to the compartment delineated by the cation membrane and bipolar membrane are at least partly performed simultaneously with the step of discharging the anolyte and catholyte.

It was found that at least partly performing the steps of discharging the anolyte and catholyte, providing freshwater including an acid to the compartment delineated by the anion membrane and bipolar membrane, and providing freshwater including a base to the compartment delineated by the cation membrane and bipolar membrane has a synergetic effect on the total voltage of the cell and enables an efficient and effective redox flow battery.

In a further presently preferred embodiment according to the invention, the acid may be one or more selected from the group of HCl, H₂SO₄, HI, and HF, and/or the base may be sodium hydroxide (NaOH) and/or potassium hydroxide (KOH).

In a preferred embodiment according to the invention, the acid may be HCl and/or H₂SO₄, preferably the acid may be HCl, and/or the base may be NaOH.

It was found that an efficient method for boosting a redox flow battery was achieved using acid and base which enable an efficient displacement reaction. For example, HCl as acid and NaOH as base, or H₂SO₄ as acid and NaOH as base, or H₂SO₄ as acid and KOH as base, or HCl as acid and KOH as base.

In a further presently preferred embodiment according to the invention, the concentration of the acid and base may be independently selected from the range of 0.5 mol L⁻¹ to 3 mol L⁻¹, preferably 0.5 mol L⁻¹ to 2 mol L⁻¹, more preferably 1 mol L⁻¹ to 1.5 mol L⁻¹.

It is noted that the concentration of the acid is independent from the concentration of the base. In other words, the concentration of the acid and the base are not correlated to each other.

It was found that providing the acid and base independently selected from said range, an efficient and effective discharge of the redox flow battery was achieved, wherein the method according to the invention provided a stable output of energy.

In a further presently preferred embodiment according to the invention, the method further comprises the steps of providing freshwater to the compartment delineated by the anion membrane and bipolar membrane and providing freshwater to the compartment delineated by the cation membrane and bipolar membrane.

It was found that providing freshwater to the compartment delineated by the anion membrane and bipolar membrane and providing freshwater to the compartment delineated by the cation membrane and bipolar membrane improves the charge capacity and total voltage of the redox flow battery.

In a preferred embodiment, the steps of providing freshwater to the compartment delineated by the anion membrane and bipolar membrane and providing freshwater to the compartment delineated by the cation membrane and bipolar membrane are at least partly performed simultaneously with the step of charging the anolyte and catholyte.

It was found that at least partly performing the steps of charging the anolyte and catholyte, providing freshwater to the compartment delineated by the anion membrane and bipolar membrane, and providing freshwater to the compartment delineated by the cation membrane and bipolar membrane has a synergetic effect on the total charge capacity and voltage of the cell and enables an efficient and effective redox flow battery.

In a further presently preferred embodiment according to the invention, n may be an integer of 2 or more, and wherein two triplets of membranes delineate an intermediate compartment.

An advantage of n is an integer of 2 or more is that the intermediate compartment enables to remove salt from the membrane device during discharge and provide ions to the membrane device during charge. As a result, a more efficient and effective redox flow battery is achieved.

It was found that adding and/or removing the ions enables to use multiple triplets of membranes and thus increasing the capacity of the membrane device. Furthermore, removing the ions during discharge and adding ions during charge increases the life-time of the membrane device by at least 25% compared to membrane devices without removing and/or adding said ions.

In a further presently preferred embodiment according to the invention, the method further comprises the step of providing freshwater or salt water to the intermediate compartment.

The step of providing freshwater or salt water to the intermediate compartment preferably includes the step of providing freshwater or salt water in an alternating manner. In other words, the intermediate compartment may be provided with salt water followed by providing the intermediate compartment with freshwater.

In a preferred embodiment, a preferred salt is dissolved in freshwater forming the desired salt water.

For example, during discharge, using HCl as acid and NaOH as base provides (dissolved) NaCl to the intermediate compartment, or H₂SO₄ as acid and NaOH as base provides (dissolved) Na₂SO₄ to the intermediate compartment, or H₂SO₄ as acid and KOH as base provides (dissolved) K₂SO₄ to the intermediate compartment, or HCl as acid and KOH as base provides (dissolved) KCl to the intermediate compartment.

In addition, during charge, salt water is provided to the intermediate compartment. For example, the salt water may be NaCl (aq), Na₂SO₄ (aq), K₂SO₄ (aq), or KCl (aq).

An advantage of selecting the salt water provided to the intermediate compartment is that fouling and/or blocking of the membrane device is prevented.

Thus, selecting the (dissolved) acid provided to the compartment delineated by the anion membrane and bipolar membrane and the (dissolved) base provided to the compartment delineated by the cation membrane and bipolar membrane during discharge, and the salt water provided to the intermediate compartment during charging such that said acid, base, and salt do not precipitate when combined is preferred. As a result, an efficient and effective redox flow battery is achieved.

In a further presently preferred embodiment according to the invention, the catholyte comprises one or more selected from the group of Na₄[FeCN]₆, K₃[FeCN]₆, Br₂/Br⁻, VO²⁺. Preferably, the anolyte comprises one or more selected from the group of FeCl₂, FeCl₃, triethanolamine, V²⁺/V³⁺, H₂/H⁺, Zn/Zn²⁺.

It was found that the catholyte selected from said group and/or the anolyte selected from said group provides an efficient and effective method for boosting a redox flow battery.

For example, VO²⁺ may have chloride ions as counterion. In other words, the catholyte may be VO²⁺/2Cl⁻.

In a further presently preferred embodiment according to the invention, the anolyte and/or catholyte comprises one or more bases independently selected from potassium hydroxide and sodium hydroxide. Preferably, the concentration of the base may be in the range of 1 mol L⁻¹ to 5 mol L⁻¹, preferably 2 mol L⁻¹ to 4 mol L⁻¹, more preferably 2.5 mol L⁻¹ to 3.5 mol L⁻¹.

An advantage of adding a base to the anolyte and/or catholyte is that the lifespan of the anolyte and/or catholyte is extended. Furthermore, the efficiency of the anolyte and/or catholyte is increased.

In a further presently preferred embodiment according to the invention, the anolyte and/or catholyte may be heated to a temperature in the range of 25° C. to 80° C., preferably in the range of 35° C. to 60° C., more preferably in the range of 35° C. to 50° C.

It was found that heating the anolyte and/or catholyte enables an efficient and effective charge and discharge of the redox flow battery. As a result, the redox flow battery may provide improved power grid stability.

In a preferred embodiment, the concentration of the anolyte and catholyte are independently selected from the range of 1 mol L⁻¹ to 5 mol L⁻¹, preferably in the range of 1.5 mol L⁻¹ to 4 mol L⁻¹, more preferably in the range of 2 mol L⁻¹ to 3.5 mol L⁻¹. Preferably, the anolyte and/or catholyte provided in said concentrations are heated to a temperature in the range of 25° C. to 80° C.

In a further presently preferred embodiment according to the invention, circulating the anolyte and circulating the catholyte is independently performed with a flushing rate in the range of 50 L min⁻¹ per cubic decimetre of the compartment to 500 L min⁻¹ per cubic decimetre of the compartment the anolyte or catholyte is circulated in, preferably in the range of 100 L min⁻¹ per cubic decimetre of the compartment to 450 L min⁻¹ per cubic decimetre of the compartment the anolyte or catholyte is circulated in, more preferably in the range of 250 L min⁻¹ per cubic decimetre of the compartment to 450 L min⁻¹ per cubic decimetre of the compartment the anolyte or catholyte is circulated in.

It is noted that circulating the anolyte and circulating the catholyte may be performed at different rates.

Flushing with the above mentioned rates, reduces the build up of undesired particles in the various compartments.

The invention also relates to a device for boosting a redox flow battery, configured to perform the method according to the invention, comprising: n triplet of membranes, wherein n may be an integer of 1 or more, and wherein each triplet of membranes consists of an anion exchange membrane, a bipolar membrane, and a cation exchange membrane; 3n+1 compartments, wherein one of the compartments comprises a cathode and wherein another of the compartments comprises an anode, and wherein the 3n+1 compartments are at least partly delineated by one of the triplet of membranes; and means for applying an electrical potential difference between the cathode and the anode, wherein the compartment comprising the anode is configured to, during use, be provided with an anolyte and the compartment comprising the cathode is configured to, during use, be provided with a catholyte.

It is noted that the device comprises triplets of membranes. Preferably, the amount of membranes is a multiple of three.

The device for boosting a redox flow battery, configured to perform the method according to the invention provides the same effects and advantages as those described for the method for boosting a redox flow battery according to the invention.

An advantage of the device according to the invention is that efficient charging and discharging is enabled. Therefore, a robust device is achieved which has an extended lifespan compared to conventional redox flow batteries.

Furthermore, the device according to the invention may be easily coupled to a power grid, enabling to balance said power grid efficiently and effectively.

In a presently preferred embodiment according to the invention, the membrane of the device consists of n triplet of membranes. Said membrane of the membrane device consists of a triplet of membranes multiplied by n.

An advantage of using n triplet of membranes is that, besides the n triplet of membranes, no additional membranes are required for boosting a redox flow battery.

In a presently preferred embodiment according to the invention, the compartment of the device consists of 3n+1 compartments.

An advantage of 3n+1 compartments is that the number of compartments is limited to the required number of compartments when n triplet of membranes is used. Therefore, the number of failures of the system are reduced as less membranes are present in the membrane device.

In a further presently preferred embodiment according to the invention, n is an integer of 2 or more, and wherein two triplets of membranes delineate an intermediate compartment.

The device according to the invention wherein n is an integer of 2 or more enables a device comprising one or more intermediate compartments. Said configuration increases the applicability of the device according to the invention. For example, the (energy) capacity of the device increases. As a result, de device according to the invention may be included in means for stabilizing the power grid.

In a further presently preferred embodiment according to the invention, the intermediate compartment is configured to, during use in a discharge state, be provided with freshwater, and configured to, during use in a charge state, be provided with salt water.

The invention also relates to a membrane stack for boosting a redox flow battery, the stack comprising a number of cells which are configured to perform the method according to the invention.

The membrane stack for boosting a redox flow battery provides the same effects and advantages as those described for the method for boosting a redox flow battery according to the invention and the device for boosting a redox flow battery.

The invention also relates to a system for boosting a redox flow battery, comprising: a device according to the invention; a first pump configured for circulating an anolyte; a second pump configured for circulating a catholyte; an anolyte storage which is operatively coupled with an anolyte buffer of the device and the first pump; and a catholyte storage which is operatively coupled with a catholyte buffer of the device and the second pump.

The system for boosting a redox flow battery provides the same effects and advantages as those described for the method for boosting a redox flow battery according to the invention, the device for boosting a redox flow battery, and the membrane stack for boosting a redox flow battery.

An advantage of the system according to the invention is that a stable power grid is achieved.

It is noted that an anolyte buffer is a storage of charged or discharged anolyte, and that a catholyte buffer is a storage of charged or discharged catholyte.

In a presently preferred embodiment according to the invention, the means to provide an electrical potential difference is a windmill, a solar panel, and/or tidal power station.

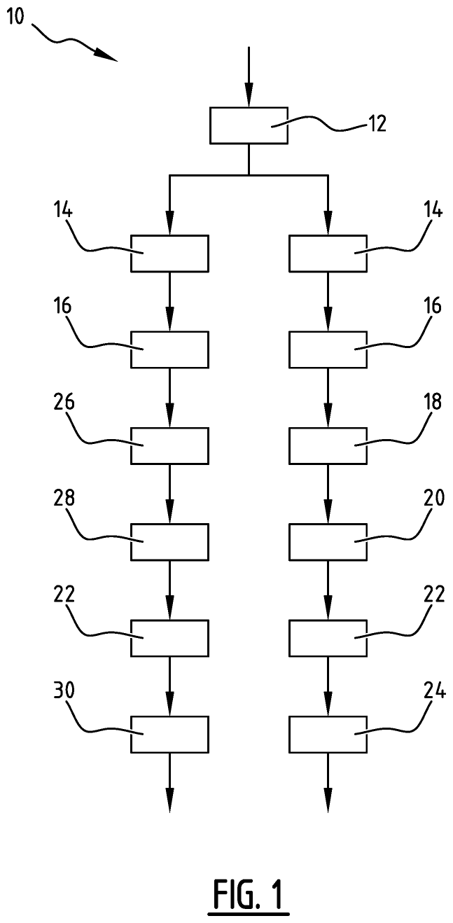

Method 10 (FIG. 1) for boosting a redox flow battery with a membrane device follows a sequence of steps.

In the illustrated embodiment method 10 may start with step 12 of providing the redox flow battery with the membrane device. In the discharging stater, step 12 may be followed by step 14 of circulating a catholyte to the compartment with the cathode and step 16 of circulating an anolyte to the compartment with the anode. Step 14 and step 16 may be followed by step 18 of providing freshwater including an acid to the compartment delineated by the anion membrane and bipolar membrane, and step 20 of providing freshwater including a base to the compartment delineated by the cation membrane and bipolar membrane. Furthermore, step 18 and step 20 may be followed by step 22 of providing freshwater or salt water to the intermediate compartment. Preferably, step 22 includes providing freshwater in the discharging state.

Step 22 may be followed by step 24 of discharging the redox flow battery. Said step may also referred to as discharging the anolyte and catholyte.

Preferably, steps 14, 16, 18, 20, 22, and 24 are performed simultaneously in the discharging state.

In the charging state, step 12 may be followed by step 14 of circulating a catholyte to the compartment with the cathode and step 16 of circulating an anolyte to the compartment with the anode. Step 12 and step 14 may be followed by step 26 of providing freshwater to the compartment delineated by the anion membrane and bipolar membrane, and step 28 of providing freshwater to the compartment delineated by the cation membrane and bipolar membrane. Furthermore, step 26 and step 28 may be followed by step 22 of providing freshwater or salt water to the intermediate compartment. Preferably, step 22 includes providing salt water in the discharging state.

Step 22 may be followed by step 30 charging the redox flow battery.

Preferably, steps 14, 16, 22, 26, 28, 30 are performed simultaneously in the charging state.

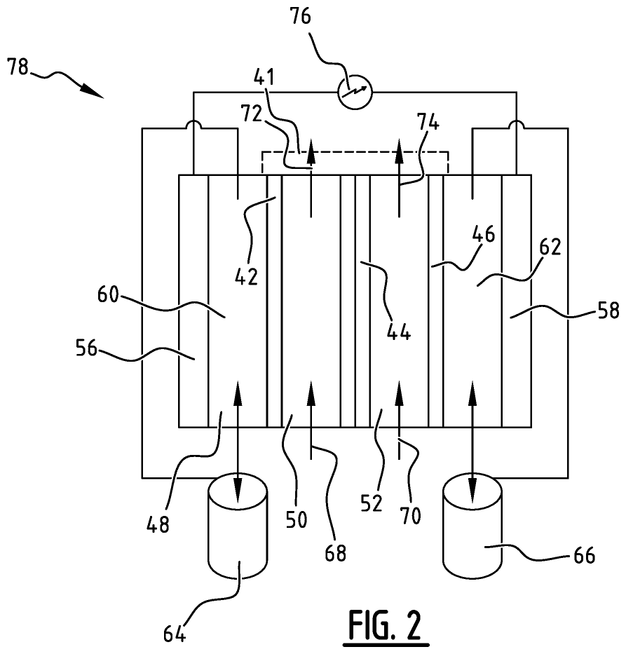

Membrane device 40 (FIG. 2) comprises triplet of membranes 41. Triplet of membranes 41 comprises an anion exchange membrane 42, bipolar membrane 44, and cation exchange membrane 46. Furthermore, membrane device 40 comprises compartments 48, 50, 52, 54, wherein compartment 48 comprises electrode 56, and compartment 54 comprises electrode 58. Furthermore, compartment 48 is at least partly delineated by anion exchange membrane 42, and compartment 54 is at least partly delineated by cation exchange membrane 46.

Compartments 50 and 52 are at least partly delineated by bipolar membrane 44 and anion exchange membrane 42 and cation exchange membrane 46 respectively.

Compartment 48 is configured for holding/circulating electrolyte 60, and compartment 54 is configured for holding/circulating electrolyte 62. Electrolyte 60 may be provided from tank 64, wherein tank 64 is operatively coupled with compartment 48. Electrolyte 62 may be provided from tank 66, wherein tank 66 is operatively coupled with compartment 54.

Compartment 50 is configured to be provided with stream 68, and compartment 52 is configured to be provided with stream 70. Stream 68 and stream 70 are removed from compartment 68 and compartment 52 via outlet 72 and outlet 74 respectively.

Membrane device 40 further comprises means 76 for applying an electrical potential difference between the cathode and the anode.

In the charging state electrode 56 is an anode, and in the discharging state electrode 56 is a cathode. Furthermore, in the charging state electrode 58 is a cathode, and in the discharging state electrode 58 is an anode.

In the charging state electrolyte 60 is catholyte, and in the discharging state electrolyte 60 is an anolyte. Furthermore, in the charging state electrolyte 62 is catholyte, and in the discharging state electrolyte 62 is an anolyte.

In the charging state stream 68 and 70 are freshwater, in the discharging state stream 68 is acidic, and stream 70 is basic.

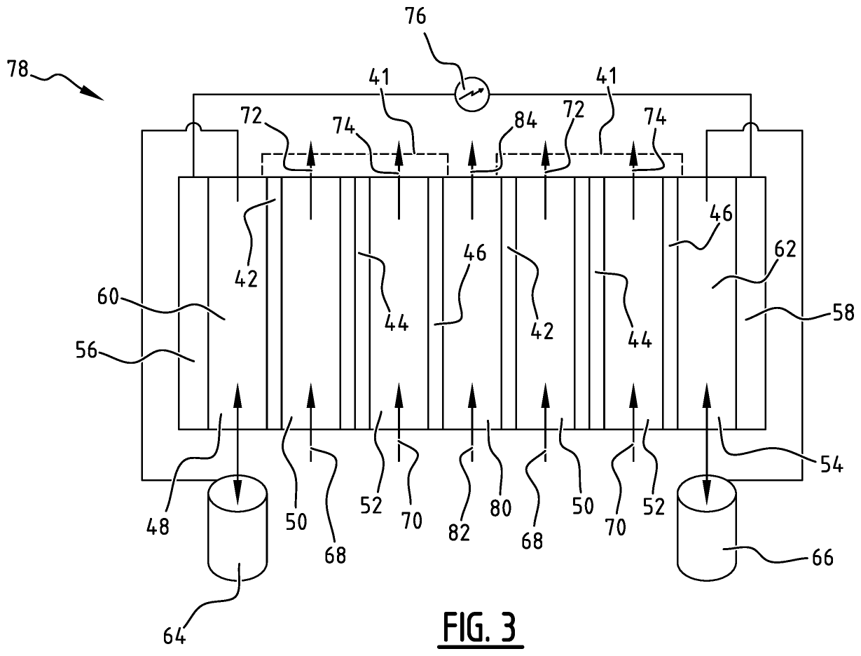

Membrane device 78 (FIG. 3) comprises two triplet of membranes 41.

Triplet of membranes 41 comprises anion exchange membrane 42, bipolar membrane 44, and cation exchange membrane 46. Furthermore, membrane device 78 comprises compartments 48, 50, 52, 54, wherein compartment 48 comprises electrode 56, and compartment 54 comprises electrode 58. Furthermore, compartment 48 is at least partly delineated by a first anion exchange membrane 42, and compartment 54 is at least partly delineated by a first cation exchange membrane 46.

Compartments 50 and 52 are at least partly delineated by bipolar membrane 44 and anion exchange membrane 42 and cation exchange membrane 46 respectively.

Compartment 48 is configured for holding/circulating electrolyte 60, and compartment 54 is configured for holding/circulating electrolyte 62. Electrolyte 60 may be provided from tank 64, wherein tank 64 is operatively coupled with compartment 48. Electrolyte 62 may be provided from tank 66, wherein tank 66 is operatively coupled with compartment 54.

Compartment 50 is configured to be provided with stream 68, and compartment 52 is configured to be provided with stream 70. Stream 68 and stream 70 are removed from compartment 68 and compartment 52 via outlet 72 and outlet 74 respectively.

Membrane device 78 further comprises intermediate compartment 80, wherein intermediate compartment 80 is at least partly delineated by cation exchange membrane 46 of a first triplet of membranes and at least partly delineated by anion exchange membrane 42 of a second triplet of membranes. Intermediate compartment 80 is configured to be provided with stream 82. Stream 82 is removed from intermediate compartment 82 via outlet 84.

Membrane device 78 further comprises means 76 for applying an electrical potential difference between the cathode and the anode.

In the charging state electrode 56 is an anode, and in the discharging state electrode 56 is a cathode. Furthermore, in the charging state electrode 58 is a cathode, and in the discharging state electrode 58 is an anode.

In the charging state electrolyte 60 is catholyte, and in the discharging state electrolyte 60 is an anolyte. Furthermore, in the charging state electrolyte 62 is catholyte, and in the discharging state electrolyte 62 is an anolyte.

In the charging state stream 68 and 70 are freshwater and stream 82 is salt water, in the discharging state stream 68 is acidic, stream 70 is basic, and stream 82 is freshwater.

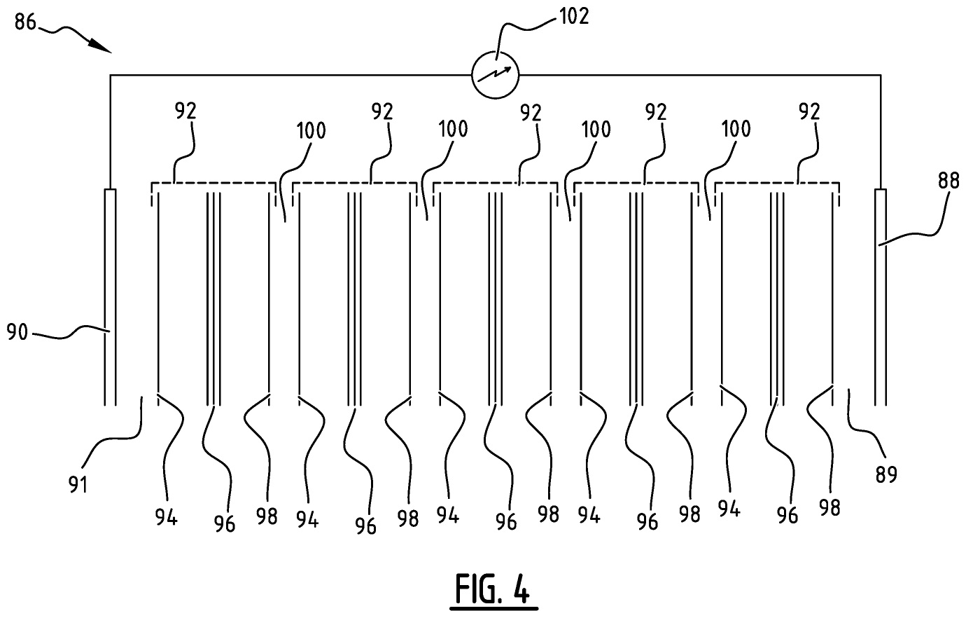

Membrane device 86 (FIG. 4) comprises multiple triplet of membranes 92. Triplet of membranes 92 comprises anion exchange membranes 94, bipolar membranes 96, and cation exchange membranes 98. Furthermore, membrane device 86 comprises intermediate compartments 100, which are at least partly delineated by cation exchange membrane 98 of a first triplet of membranes and anion exchange membrane 94 of a second triplet of membranes.

Membrane device 86 further comprises compartment 91 which is partly delineated by anion exchange membrane 94 of the first triplet of membranes 92 and compartment 89 which is partly delineated by cation exchange membrane 98 of the last triplet of membranes 92. Compartment 89 comprises electrode 88 and compartment 91 comprises electrode 90.

It is noted that the intermediate compartments are formed between two triplet of membranes, except from the compartments comprising an electrode which are at least partly delineated a membrane of the triplet of membranes.

In an experiment the method according to the invention was compared with a conventional redox flow battery.

The method according to the invention was deployed on a conventional all iron redox flow battery, wherein a complexed FeCl₂ and FeCl₃ as an anolyte and a K₃FeCN₆+Na₄FeCN₆ catholyte, being pumped through two compartments of the cell, on either side of an anion exchange membrane.

To facilitate this, two redox-active electrolytes were prepared: Anolyte—Iron (II) and Iron (III) complexed with Triethanolamine (TEA) and dissolved in aqueous NaOH:

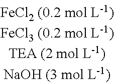

Total volume is 200 mL

Catholyte—Iron ferri and ferrocyanide dissolved in aqueous NaOH:

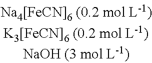

Total volume is 200 mL

The electrolytes (anolyte and catholyte) described above, when recirculated in a cell with two compartments separated by a cation-exchange membrane (CEM), form the conventional all-iron redox flow battery. The booster part requires two additional chemicals:

Anolyte side:
200 mL of 1 mol L⁻¹ HCl solution
   Catholyte side:
200 mL of 1 mol L⁻¹ NaOH solution

The above description concludes the chemical aspect of the non-boosted (conventional) and boosted redox flow batter.

The device of a conventional redox flow battery comprises two compartments separated by a cation exchange membrane. The channels were made out of gaskets with integrated netting. The active area of the channels was 10 cm×2 cm, while the thickness of the channels was 488 μm. The cation exchange membrane was sourced from Fumatech and a titanium mesh was used as electrode. The electrolytes were pumped through the cell in a closed loop with the reservoir using a peristaltic pump sourced from Cole Palmer Inc.

The device for boosting a redox flow battery according to the invention, is shown in FIG. 2. The following components are included in said device according to the invention: a bipolar membrane—sourced from Fumatech; and 1 mol L⁻¹ HCl and 1 mol L⁻¹ NaOH compartment on either side of the bipolar membrane

To separate the HCl from the anolyte, an anion exchange membrane, sourced from Fumatech, was used. The spacers used as acid and base channels were identical in active area and thickness to the electrolyte spacers.

The conventional redox flow battery and the device for boosting a redox flow battery according to the invention were electrochemically tested under identical conditions. Before applying the current, the open circuit voltage of the cell was recorded. Following this, the following testing method was implemented:
Electrolyte flow rate (400 mL min⁻¹)
Acid/Base flow rate (120 mL min⁻¹)
Applied current (12.5 A m⁻²≤Iₐ≤100 A m⁻²)
Charging and discharging time (600 seconds (10 minutes)). Total cycle time (20 minutes)
Cell voltage was measured every 1 second.

The method above was implemented via a potensiostat, sourced from Autolab. The conventional device was tested first and then, fresh electrolytes were used for the device for boosting a redox flow battery.

The cell was also tested at an elevated temperature of 40° C. This was facilitated by heating all the streams entering the cell, i.e. acid, base, salt and the two electrolytes over a hotplate. The temperature of the reservoirs was controlled by a temperature sensor dipped into the Fe-TE electrolyte and connected to the hotplate.

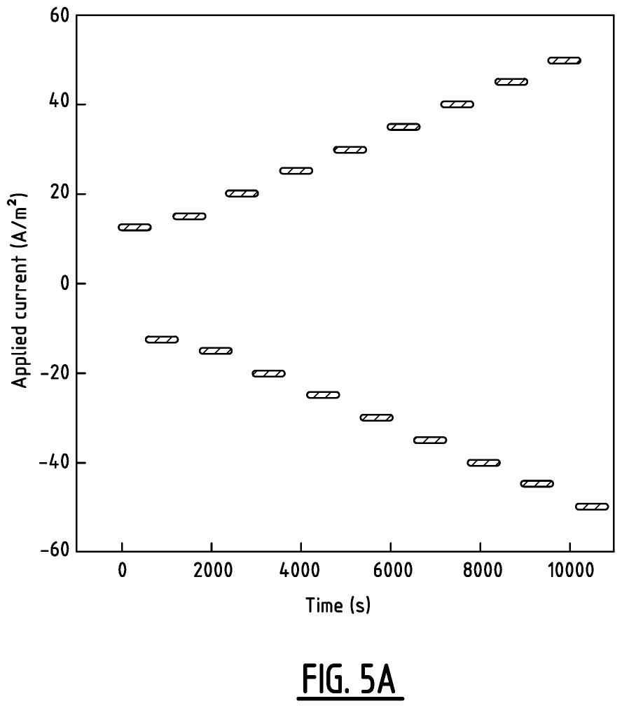

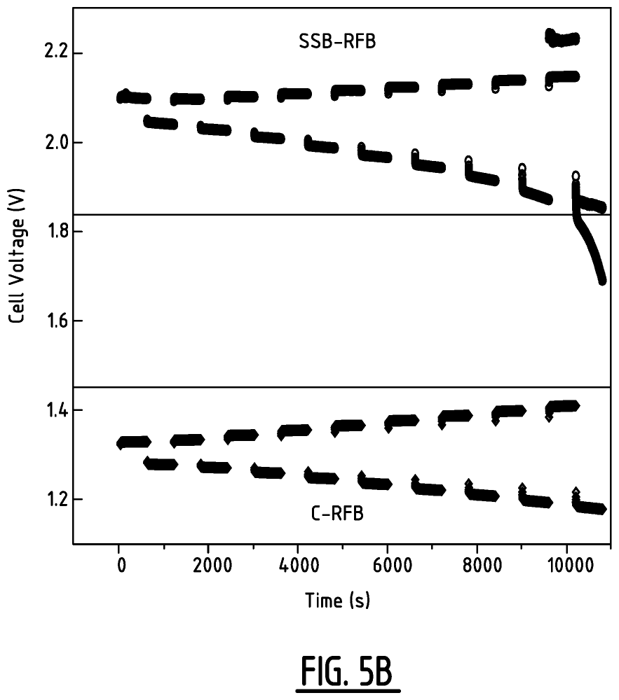

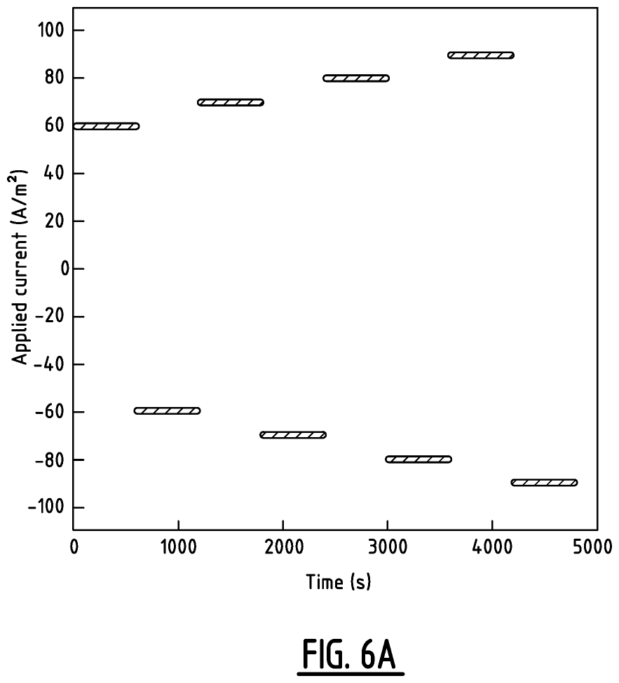

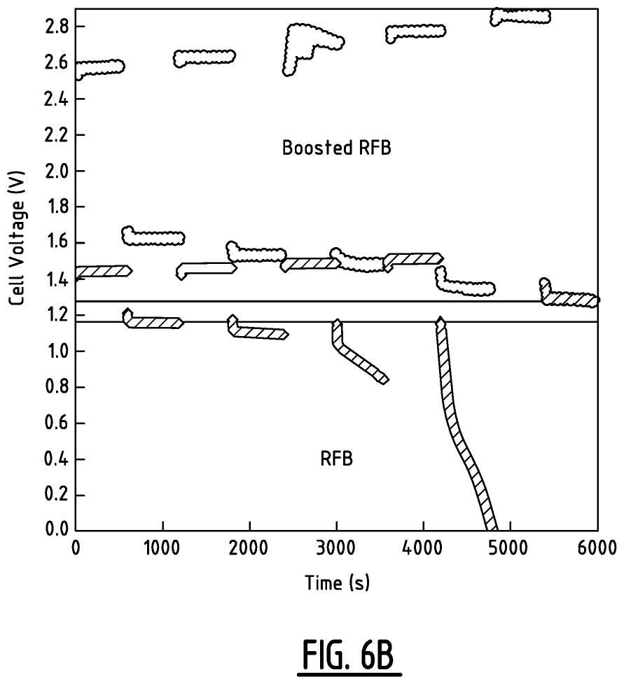

The testing method, as described in above, resulted in a current-voltage signal shown in FIG. 5 for 12.5 A m⁻² to 50 A m⁻² and FIG. 6 for 50 A m⁻² to 100 A m⁻². FIG. 5 shows in FIG. 5A a profile of the current sweep applied to the two different cells for charging as well as discharging until 50 A m⁻², and FIG. 5B shows the corresponding voltage profiles, as recorded for both. The electrolyte was refreshed for 50 A m⁻².

The lines at a cell voltage of 0 V to 1.45 V are directed to the conventional device and the cell voltage of 1.8 V to 2.3 V are directed to the device for boosting a redox flow battery according to the invention.

FIG. 6A shows a profile of the current sweep applied to the two different cells for charging as well as discharging from 50 to 100 A m⁻², and FIG. 6B shows the corresponding voltage profiles, as recorded for both devices.

From the cell voltage data in FIGS. 5 and 6, it is evident that the voltage, upon addition of a bipolar membrane, an increases by a step of ≈0.8V as the open circuit voltage is achieved. A measure of the maximum potential of a battery rises nearly 60%.

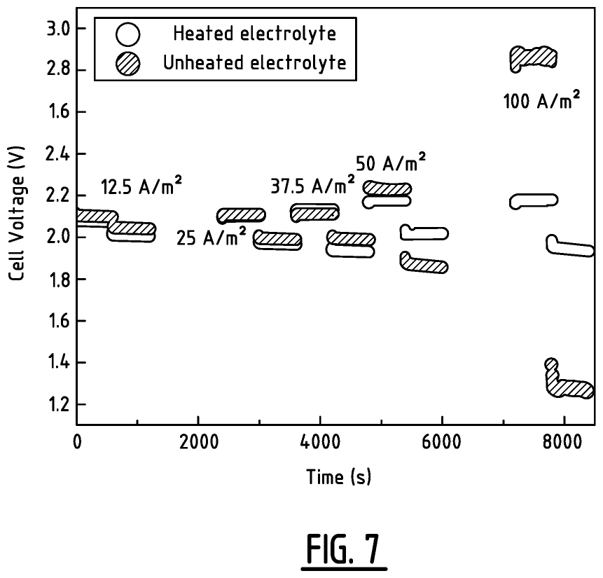

Heating the flow streams influences the voltage response of the cell as well, as shown in FIG. 7. An increase in total cell voltage in the device for boosting a redox flow battery may operate at lower current density, for example a lower current density of about 60% compared to a conventional system and deliver the same power Thus, the gross power from the device for boosting a redox flow battery according to the invention increases. It is unexpected that for the same current density, the gross power output for the method and device for boosting a redox flow battery is significantly higher compared conventional methods and devices. This is a clear advantage over the conventional methods and devices.

In a further experiment, a redox flow battery with the membrane device having n is 1 was provided with the following redox couple:

$${Zn}^{2 +} + 2 {e}^{-} ↔ Zn ( s ) \qquad {E}_{Anolyte}^{0} = - 0.76 vs . SH E$$

$${Fe ( CN )}_{6}^{3 -} + {e}^{-} ↔ {Fe ( CN )}_{6}^{4 -} \qquad {E}_{Catholyte}^{0} = + 0.36 vs . SH E$$

A Zn foil, placed on top of a carbon electrode, acts as anode. The E⁰_{cell} for this combination, at neutral pH, is 1.12V. The commercialized Zn—Fe system works in alkaline conditions with both active species present as an anion (Fe(CN)₆³⁻ and Zn(OH)₄²⁻). The Zn—Fe combination also works in acidic media with the active species present as Zn²⁺ and Fe³⁺ cations. The combination fails in neutral media due to the crossover of either Zn or Fe since neither anion exchange membrane nor cation exchange membrane can block both cations and anions. This results in formation of a precipitate at the membrane interface resulting in immediate E_{cell} loss.

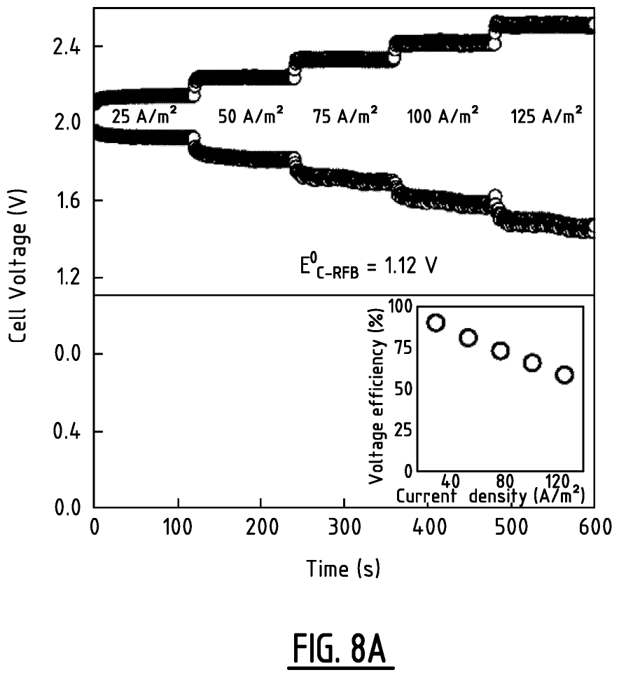

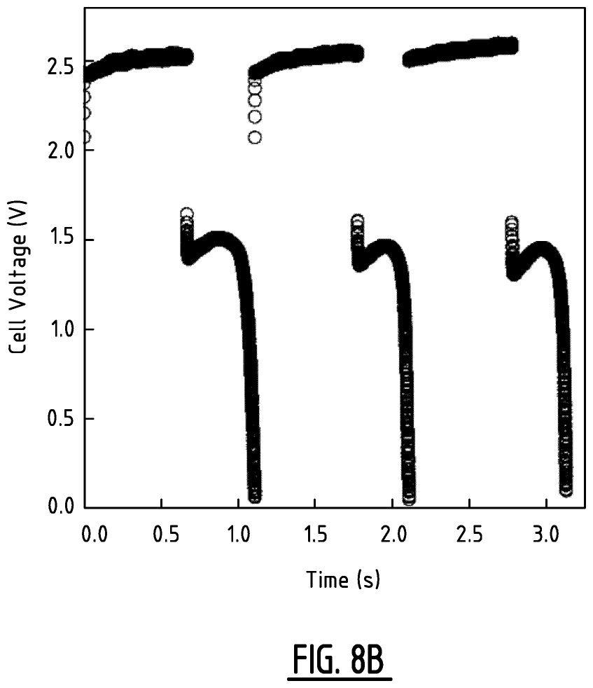

It was found that the method according to the invention enables coupling of two unlikely redox species and boosts power of the resulting cell, as shown in the E_{cell} curves of FIG. 8A, measured under five current densities.

While a relative increase in voltage and consequently, power, in boosting the redox flow battery over conventional redox flow battery cannot be calculated since the redox couples do not work as a conventional redox flow battery, it is still clear that the E⁰_{cell} using the method according to the invention is nearly 60% higher than that of conventional redox flow batteries.

Finally, the Zn—Fe used in the method according to the invention was cycled at 100 A m⁻² and the results are presented in FIG. 8D. The addition of the booster cell enables cycling of the neutral Zn—Fe redox couple. The resulting battery can reversibly charge and discharge. On average a voltage efficiency per cycle of 55% has been achieved. A fraction of this is attributable to the ohmic resistance within the system, evident from the linear drop in voltage efficiency with increasing current.

Thus, the method according to the invention boosts the gross power density and, the energy density of the used redox flow battery.

The present invention is by no means limited to the above described preferred embodiments and/or experiments thereof. The rights sought are defined by the following claims within the scope of which many modifications can be envisaged.

1. A method for boosting a redox flow battery with a membrane device, the method comprising the steps of:
providing the redox flow battery with the membrane device comprising:
n triplet of membranes, wherein n is an integer of 1 or more, wherein a triplet of membranes consists of an anion exchange membrane, bipolar membrane, and a cation exchange membrane, and wherein a membrane of the membrane device consists of n triplet of membranes; and
3n+1 compartments, wherein a first compartment comprises a cathode and wherein a second compartment comprises an anode, and wherein the 3n+1 compartments are at least partly delineated by one of the triplet of membranes;
circulating a catholyte to the first compartment with the cathode;
circulating an anolyte to the second compartment with the anode;
charging the redox flow battery by at least one of:
applying an electrical potential difference between the anode and the cathode; and
providing charged catholyte to the first compartment with the cathode and anolyte to the second compartment with the anode;
providing freshwater including an acid to a compartment delineated by the anion exchange membrane and the bipolar membrane; and
providing freshwater including a base to a compartment delineated by the cation exchange membrane and the bipolar membrane.

2. (canceled)

2. The method of claim 1, wherein a compartment of the membrane device consists of 3n+1 compartments.

3. The method of claim 1, further comprising discharging the redox flow battery.

5. (canceled)

4. The method of claim 1, wherein the acid is at least one of HCl, H₂SO₄, HI, and HF.

5. The method of claim 1, wherein the base is at least one of sodium hydroxide and potassium hydroxide.

6. The method of claim 1, wherein a concentration of the acid and the base are independently selected within a range of 0.5 mol L⁻¹ to 3 mol L⁻¹.

7. The method of claim 1, further comprising providing freshwater to the compartment delineated by the anion exchange membrane and bipolar membrane and providing freshwater to the compartment delineated by the cation exchange membrane and bipolar membrane.

8. The method of claim 1, wherein n is an integer of 2 or more, and wherein two triplets of membranes delineate an intermediate compartment.

9. The method of claim 8, further comprising providing at least one of freshwater and salt water to the intermediate compartment.

10. The method of claim 1, wherein the catholyte comprises at least one of Na₄[FeCN]₆, K₃[FeCN]₆, Br₂/Br⁻, VO²⁺.

11. The method of claim 1, wherein the anolyte comprises at least one of FeCl₂, FeCl₃, triethanolamine, V²⁺/V³⁺, H₂/H⁺, Zn/Zn²⁺.

12. The method of claim 1, wherein at least one of the anolyte and the catholyte comprises a base independently selected from potassium hydroxide and sodium hydroxide.

13. The method of claim 12, wherein a concentration of the base is in the range of 1 mol L⁻¹ to 5 mol L⁻¹.

14. wherein at least one of the anolyte and the catholyte are heated to a temperature in the range of 25° C. to 80° C.

15. The method of claim 1, wherein circulating the anolyte and circulating the catholyte is independently performed with a flushing rate in the range of 50 L min⁻¹ per cubic decimetre of the compartment to 500 L min⁻¹ per cubic decimetre of the compartment the anolyte or catholyte is circulated in.

16. A device for boosting a redox flow battery, configured to perform the method according to any one of the preceding claims, comprising:
n triplet of membranes, wherein n is an integer of 1 or more, and wherein a triplet of membranes consists of an anion exchange membrane, a bipolar membrane, and a cation exchange membrane, and wherein a membrane of the device consist of n triplet of membranes;
3n+1 compartments, wherein a first compartment comprises a cathode and wherein a second compartment comprises an anode, and wherein the 3n+1 compartments are at least partly delineated by one of the triplet of membranes; and
a means for applying an electrical potential difference between the cathode and the anode,
wherein the second compartment comprising the anode is configured to, during use, be provided with an anolyte and the first compartment comprising the cathode is configured to, during use, be provided with a catholyte, wherein an intermediate compartment is configured to, during use in a discharge state, be provided with freshwater, and configured to, during use in a charge state, be provided with salt water.

19. (canceled)

17. The device of claim 16, wherein a compartment of the device consists of 3n+1 compartments.

18. The device of claim 16, wherein n is an integer of 2 or more, and wherein two triplets of membranes delineate an intermediate compartment.

22. (canceled)

23. (canceled)

19. A system for boosting a redox flow battery, comprising:
a device for boosting a redox flow battery comprising:
n triplet of membranes, wherein n is an integer of 1 or more, wherein a triplet of membranes consists of an anion exchange membrane, a bipolar membrane, and a cation exchange membrane, and wherein a membrane of the device consists of n triplet of membranes;
3n+1 compartments, wherein a first compartment comprises a cathode and a second compartment comprises an anode, and wherein the 3n+1 compartments are at least partly delineated by one of the triplet of membranes; and
a means for applying an electrical potential difference between the cathode and the anode,
wherein the second compartment comprising the anode is configured to, during use, be provided with an anolyte and the first compartment comprising the cathode is configured to, during use, be provided with a catholyte, wherein an intermediate compartment is configured to, during use in a discharge state, be provided with freshwater, and configured to, during use in a charge state, be provided with salt water;
a first pump configured for circulating the anolyte;
a second pump configured for circulating the catholyte;
an anolyte storage which is operatively coupled with an anolyte buffer of the device and the first pump; and
a catholyte storage which is operatively coupled with a catholyte buffer of the device and the second pump.

20. The system of claim 19, wherein the means to provide the electrical potential difference is at least one of a windmill, a solar panel, and a tidal power station.
